(19) United States
(12) Patent Application Publication
(10) Pub. No.: US 2026/0331711 A1
(43) Pub. Date: Oct. 22, 2026

(54) BATTERY MODULE

(71) Applicant: SAMSUNG SDI CO., LTD., Yongin-si (KR)

(72) Inventor: SISEONG KANG, Yongin-si (KR)

(21) Appl. No.: 19/416,173

(22) Filed: Dec. 11, 2025

(30) Foreign Application Priority Data
Apr. 22, 2025 (KR) 10-2025-0052269

(51) Int. Cl. H01M 50/503; H01M 50/204; H01M 50/264; H01M 50/271; H01M 50/519

(52) U.S. Cl. CPC H01M 50/503; H01M 50/264; H01M 50/271; H01M 50/519; H01M 50/204

(57) ABSTRACT

Disclosed is a battery module including a plurality of battery cells, one or more busbars configured to electrically connect the plurality of battery cells, and a holder on the plurality of battery cells and configured to accommodate the busbars, wherein the holder includes a honeycomb structure, and the one or more busbars are on the honeycomb structure.

### CROSS-REFERENCE TO RELATED APPLICATION

This application is based on and claims priority under 35 U.S.C. § 119 to Korean Patent Application No. 10-2025-0052269, filed in the Korean Intellectual Property Office on Apr. 22, 2025,, the disclosure of which is incorporated by reference herein in its entirety.

### BACKGROUND

### 1. Field

Embodiments of the disclosure relate to a battery module.

### 2. Description of the Related Art

Secondary batteries are batteries which may be charged and discharged, unlike non-rechargeable primary batteries. Low-capacity battery cells are used in portable small electronic devices such as smartphones, feature phones, laptop computers, digital cameras, and camcorders, whereas high-capacity battery cells are widely used as motor driving power sources, power storage batteries, and the like in hybrid vehicles, electric vehicles, and the like. These battery cells each include an electrode assembly including a positive electrode and a negative electrode, a case which houses the electrode assembly, electrode terminals connected to the electrode assembly, and the like.

High-capacity battery cells may be used as battery modules where a plurality of battery cells (e.g., for driving motors in hybrid vehicles) are connected in series and/or in parallel to provide high energy density.

The information described in the description of the related art section is intended to enhance understanding of the background of the disclosure only and may therefore include information which does not constitute prior art.

### SUMMARY

Embodiments of the disclosure are directed to a battery module which reduces or prevents short-circuiting between battery cells.

Embodiments of the disclosure are directed to a battery module which may manage (e.g., stably manage) a volume change caused by charging and discharging of a battery.

Embodiments of the disclosure are directed to a battery module which includes a plurality of battery cells and a holder having improved adhesive performance.

However, the technical problems to be solved by the disclosure are not limited to those described above, and other problems not mentioned will be apparent to a person of ordinary knowledge in the art from the following description of the disclosure.

Embodiments of the disclosure are directed to a battery module including: a plurality of battery cells; one or more busbars configured to electrically connect the plurality of battery cells; and a holder on the plurality of battery cells and configured to accommodate the busbars, wherein the holder includes a honeycomb structure, and the one or more busbars are on the honeycomb structure.

In an embodiment, the battery module may further include a housing configured to house the plurality of battery cells.

In an embodiment, the battery module may further include a fastener configured to fasten the holder and the housing.

In an embodiment, the battery module may further include an adhesive portion configured to bond the plurality of battery cells and the holder.

In an embodiment, the adhesive portion may include an adhesive material, all or part of which is injected into the honeycomb structure.

In an embodiment, the battery module may further include a cover positioned on the holder and configured to cover the busbars.

In an embodiment, the battery module may further include an upper cover configured to cover the cover, wherein the cover is coupled to the upper cover.

In an embodiment, the holder may have a thickness of 1.0 mm to 10 mm.

In an embodiment, the honeycomb structure may have a triangular lattice structure.

In an embodiment, one side of the honeycomb structure may have a length of 1.0 mm to 10 mm.

Other embodiments of the disclosure provide a battery module including: a plurality of battery cells; busbars configured to electrically connect the plurality of battery cells; a holder positioned on the plurality of battery cells and configured to accommodate the busbars; and a printed circuit board positioned on the holder and electrically connected to the busbars, wherein the holder includes a honeycomb structure, and the printed circuit board and the busbars are positioned on the honeycomb structure.

In an embodiment, the battery module may further include a housing configured to house the plurality of battery cells.

In an embodiment, the battery module may further include a fastener configured to fasten the holder and the housing.

In an embodiment, the battery module may further include an adhesive portion configured to bond the plurality of battery cells and the holder.

In an embodiment, the adhesive portion may include an adhesive material, all or part of which is injected into the honeycomb structure.

In an embodiment, the battery module may further include a cover on the holder and configured to cover the busbars.

In an embodiment, the battery module may further include an upper cover configured to cover the cover, wherein the cover is coupled to the upper cover.

In an embodiment, the holder may have a thickness in a range from approximately 1.0 mm to approximately 10 mm.

In an embodiment, the honeycomb structure may have a triangular lattice structure.

In an embodiment, one side of the honeycomb structure may have a length in a range from approximately 1.0 mm to to approximately 10 mm.

### BRIEF DESCRIPTION OF THE DRAWINGS

The accompanying drawings illustrate example embodiments of the disclosure and, together with the following detailed description, serve to provide further understanding of the technical spirit of the disclosure, and the disclosure is therefore not to be construed as being limited to the drawings:

FIG. 1 is an exploded perspective view of a battery module according to one or more embodiments of the disclosure;

FIG. 2 is a cross-sectional view of a cover and busbars of the battery module shown in FIG. 1 according to one or more embodiments of the disclosure;

FIG. 3 is another cross-sectional view of a cover and a busbar of the battery module shown in FIG. 1 according to one or more embodiments of the disclosure;

FIG. 4 is a perspective view of a battery cell of the battery module shown in FIG. 1 according to one or more embodiments of the disclosure;

FIG. 5 is a cross-sectional view of the III-III′ cross-section shown in FIG. 4 according to one or more embodiments of the disclosure;

FIG. 6 is a perspective view of a holder including busbars in the battery module shown in FIG. 1 according to one or more embodiments of the disclosure;

FIG. 7 is an enlarged view of the holder shown in FIG. 6 according to one or more embodiments of the disclosure; and

FIG. 8 is a perspective view of a rear side of the holder shown in FIG. 6 according to one or more embodiments of the disclosure.

### DETAILED DESCRIPTION

The disclosure may be modified in various ways and may have various embodiments, and specific embodiments will be illustrated in the accompanying drawings and described in detail with reference to the drawings. However, this is not intended to limit the disclosure to the specific embodiments, and the disclosure should be construed to encompass various changes, equivalents, and substitutions within the technical scope and spirit of the disclosure. In the following description of the disclosure, a detailed description of related known technology will be omitted in a situation in which the subject matter of the disclosure may be rendered rather unclear thereby.

Terms, such as “first” and “second”, may be used to describe various elements, but these elements should not be limited by these terms. These terms are used only to distinguish one element from another, and unless otherwise stated, it is to be understood that a first component could be termed as a second component.

Terms used herein are used to describe particular embodiments and are not intended to limit the disclosure. Singular forms are intended to include plural forms, unless the context clearly indicates otherwise. In the drawings, elements are exaggerated, omitted, or depicted schematically for ease and clarity of explanation, and the size of each element does not necessarily reflect the actual size of the component.

In the description of each element, in an embodiment in which the element is described as being formed “on” or “under” another element, the term “on” or “under” means that the element may be formed on or under the other element either directly or via an intervening element, and the reference for “on” and “under” is based on the drawings.

Hereinafter, embodiments of the disclosure will be described in detail with reference to the accompanying drawings, and in the description with reference to the accompanying drawings, identical or corresponding components are assigned with the same reference numerals, and repetitive descriptions are omitted.

Additionally, when used herein, the words “comprise or include” and/or “comprising or including” specify the presence of stated features, numbers, steps, operations, members, elements, and/or groups thereof, but do not preclude the presence or addition of one or more other features, numbers, operations, members, elements and/or groups thereof.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

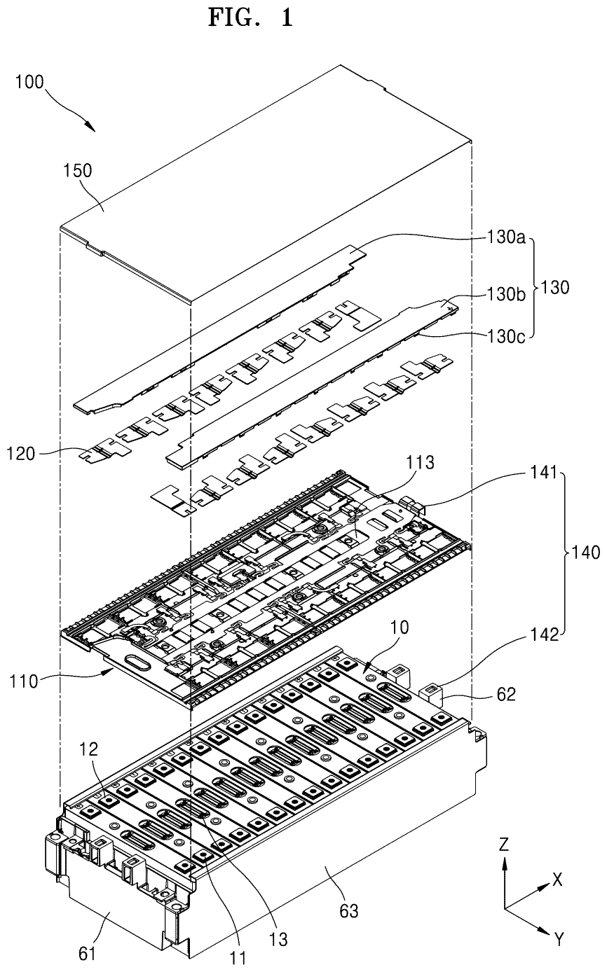

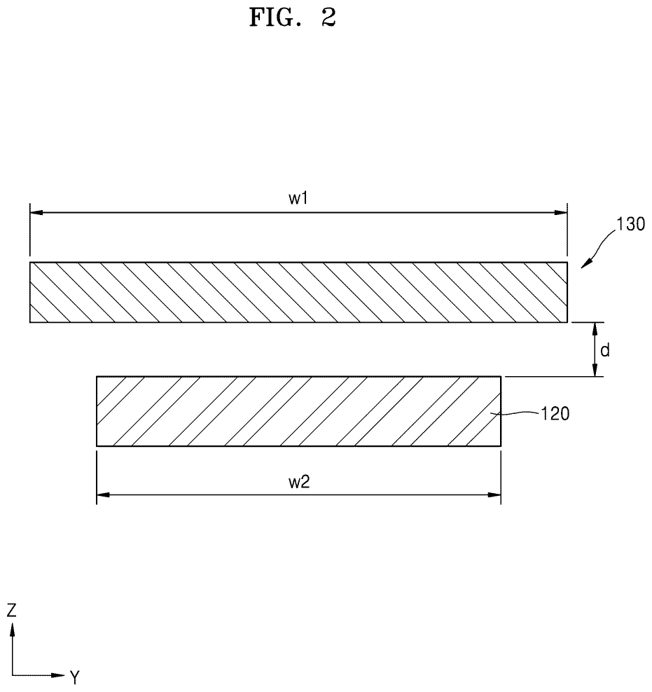

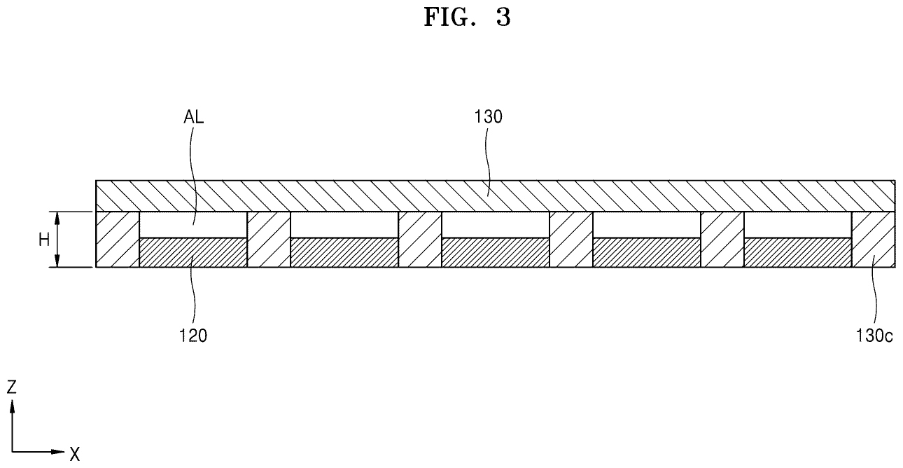

FIG. 1 is an exploded perspective view of a battery module according to one or more embodiments of the disclosure, FIG. 2 is a cross-sectional view of a cover and busbars of the battery module shown in FIG. 1 according to one or more embodiments of the disclosure. FIG. 3 is another cross-sectional view of a cover and a busbar of the battery module shown in FIG. 1 according to one or more embodiments of the disclosure.

Referring to FIGS. 1 to 3, a battery module 100 may include a plurality of battery cells 10, busbars 120 electrically connecting the plurality of battery cells 10, and a holder 110 positioned on the plurality of battery cells 10 and accommodating the busbars 120.

The battery module 100 according to embodiments of the disclosure may include the plurality of battery cells 10 arranged in one direction X and the busbars 120 electrically connecting any of the battery cells 10 to other battery cells 10 adjacent thereto.

A first terminal 11 of any battery cell 10 of the battery cells 10 may be electrically connected to a second terminal 12 of an adjacent battery cell 10 via a busbar 120, and a second terminal 12 of the battery cell 10 may be electrically connected to a first terminal 11 of another adjacent battery cell 10 via another busbar 120. Although FIG. 1 illustrates a series connection, this structure is not intended to be limiting, and various connection structures may be used as desired. Furthermore, the number and the arrangement of the battery cells 10 are not limited to the structure shown in FIG. 1 and may be modified as desired.

The plurality of arranged battery cells 10 may be accommodated by a housing 60. The housing 60 may include a pair of end plates 61 and 62 facing wide surfaces of the battery cells 10, as well as side plates 63 and a bottom plate (not shown) connected to the pair of end plates 61 and 62.

The side plates 63 support the sides of the battery cells 10, and the bottom plate (not shown) may support the bottom surfaces of the battery cells 10. In some embodiments, the pair of end plates 61 and 62, the side plates 63, and the bottom plate (not shown) may be connected using, without limitation, connecting members such as bolts, and may use any method which may enable the fastening.

The battery module 100 includes the holder 110 positioned on the plurality of battery cells 10 and accommodating busbars 120, a cover 130 positioned on the holder 110 and covering the busbars 120, and an upper cover 150 coupled to the housing 60 to accommodate the plurality of battery cells 10, the holder 110, and the cover 130.

The housing 60 and the upper cover 150 may be connected using, without limitation, a fastener such as a bolt, and may use any method which may enable the fastening. For example, the housing 60 and the upper cover 150 may be coupled to each other to form an internal space, and the plurality of battery cells 10, the holder 110, and the cover 130 may be accommodated in the internal space.

In some embodiments, the material of housing 60 and the upper cover 150 is configured to protect the plurality of battery cells 10, the holder 110, and the cover 130 from mechanical shock or thermal shock. The material of the housing 60 and the upper cover 150 may include, for example, any one of, but not limited to, acrylonitrile butadiene styrene (ABS), polycarbonate (PC), polypropylene (PP), aluminum, or stainless steel.

The holder 110 is positioned on the plurality of battery cells 10, and may accommodate the busbars 120. The holder 110 may include a sensor which performs various protective functions to improve the stability and service life of the battery module 100. For example, the sensor may be connected to a battery management system (BMS).

Terminals for temperature measurement and/or voltage measurement may be attached to each of the busbars 120, and the measured information may be transmitted to the sensor via trace lines for integral management.

Each of the plurality of battery cells 10 may include a vent 13, such as, for example, a gas discharge passage, in the upper portion. The holder 110 may further include holes 113 overlapping the vents 13. The holes 113 may serve as exhaust passages for high-temperature gas being discharged through the vents 13 in the event the temperature of the battery cells 10 increases.

The cover 130 is positioned on the holder 110, and may cover the busbars 120. The cover 130 may cover the spaced-apart busbars 120 as a single structure, as shown in FIG. 1.

In an embodiment in which the battery module 100 includes the cover 130, the cover 130 may protect the busbars 120 from mechanical impact and lessen the chance or prevent the busbars 120 from short-circuiting, to improve the stability of the battery module.

In some embodiment, in the event thermal runaway occurs in the battery module 100, foreign matter may be generated in the battery module 100. For example, the foreign matter may be fragments of a broken battery cell 10 The fragments may be a conductive material which the battery cell 10 includes. In the event of thermal runaway, the upper cover 150 may be broken, where fragments of the upper cover 150 may also include a conductive material. In the event of thermal runaway of the battery module 100, the cover 130 may cover the busbars 120 to lessen the chance or prevent the busbars 120 from coming into contact with the fragments, and lessen the chance or prevent the busbars 120 from short-circuiting, which may otherwise cause additional secondary thermal runaway.

Although in some embodiments the cover 130 includes electrical insulation, prolonged use may cause the cover 130 to deteriorate, absorb moisture, or be contaminated, forming a path through which current may flow. In such a case, the cover 130 may come into contact with the busbars 120 and cause a short circuit and a fire.

In some embodiments the cover 130 may include a plurality of covers 130a and 130b spaced apart from each other. Between the plurality of covers 130a and 130b spaced apart from each other, the holes 113 of the holder 110 may be exposed. With the plurality of covers 130a and 130b exposing the holes 113, in the event gas is discharged through the vents 13 due to the increased temperature of the battery cell 10, a discharge path for the high-temperature gas may form to help improve the stability of the battery module 100. The cover 130 is shown in FIG. 1 as including two covers 130a and 130b, but the number of covers 130 is not limited to two and may change as desired.

In some embodiments, the distance d between the upper surface of each of the busbars 120 and the lower surface of the cover 130 may be in a range from approximately 0.1 mm to approximately 5 mm.

In the event the separation distance d between the upper surface of the busbar 120 and the lower surface of the cover 130 is less than 0.1 mm, a current flow path may form in the cover 130 due to the deterioration, moisture absorption, or contamination of the cover 130, and any mechanical shock or the like applied to the battery module 100 may result in contact between the busbar 120 and the cover 130, which may cause a short circuit due to the short separation distance d between the upper surface of busbar 120 and the lower surface of cover 130. In the event the separation distance d between the upper surface of the busbar 120 and the lower surface of the cover 130 is greater than 5 mm, the integration density of the battery module 100 may decrease.

In some embodiments, because the busbar 120 and the cover 130 are separated from each other, an air gap AL containing air may be formed in a space between the busbar 120 and the cover 130. Because air has low thermal conductivity and low electrical conductivity, the air gap AL may provide thermal and electrical insulation. For example, at room temperature, air has a thermal conductivity of 0.024 W/(m·K) and an electrical conductivity of 10⁻¹⁴ (S/m). Therefore, the configuration of the battery module 100 including the air gap AL may more effectively lessen the chance or prevent heat transfer during thermal runaway of the battery module 100.

In the event a current flow path forms due to the deterioration, moisture absorption, or contamination of the cover 130, the air gap AL, which may provide an electrical insulating layer, may lessen the chance or prevent current flowing from the busbar 120 to the cover 130 to improve the stability of the battery module 100.

In some embodiments, in order for the cover 130 to protect the busbars 120, the width w1 of cover 130 may be greater than the width w2 of each of the busbars 120. The width w1 of the cover 130 and the width w2 of the busbar 120 refer to lengths measured in a direction y perpendicular to a direction x in which the battery cells are arranged.

In the event the width w1 of the cover 130 is less than or equal to the width w2 of the busbar 120, the cover 130 may not fully cover the busbar 120 to cause the above-described fragments to come into contact with the busbar 120, which may cause a short circuit and the risk of additional thermal runaway.

The cover 130 may further include protrusions 130c protruding toward the battery cells 10. The protrusions 130c may be arranged between any two adjacent busbars 120, respectively. For example, the lower surfaces of the protrusions 130c may be positioned at a lower position than the upper surfaces of the busbars 120.

Because the protrusions 130c are positioned between busbars 120, the protrusions 130c may be formed of a material having excellent durability, heat resistance, insulation properties, and flexibility. In some embodiments, the protrusions 130c may include at least one of flame-retardant silicone, ethylene propylene diene monomer (EPDM), fluorosilicone, Teflon or polytetrafluoroethylene (PTFE), para-aramid fiber, fluorine rubber or fluoroelastomer (FKM), polyvinyl chloride (PVC), or polyurethane.

In an embodiment in which the protrusions 130c are positioned between the busbars 120, the battery module 100 may fix the busbars 120 in the event the battery module 100 shifts due to external impact or the like. As a result, fracturing of the welded portions between the busbars 120 and the battery cells 10 may be reduced or prevented.

In an embodiment in which the cover 130 includes the protrusions 130c protruding toward the battery cells 10 and the protrusions 130c are each arranged between any two adjacent busbars 120 among the busbars 120, in the event that thermal runaway occurs in the battery module 100, the protrusions 130c may protect the sides of the busbars 120 to prevent or reduce the chance of the above-described fragments from coming into contact with the busbars 120 and cause a short circuit, and lessen the chance or prevent heat transfer between the busbars 120 to help improve the stability of the battery module 100.

The length H of each of the protrusions 130c may be in a range from approximately 2 mm to approximately 4 mm. Because the cover 130 is spaced apart from the busbars 120, in a case in which the length H of the protrusions 130c is less than 2 mm, the protrusions 130 c may be too short to adequately cover the sides of the busbars 120. Furthermore, in a case in which the length H of the protrusions 130c is greater than 4 mm, the protrusions 130 c may be excessively long and potentially cause material waste.

In some embodiments, the battery module 100 may further include a fastener 140 for fastening the holder 110 and the housing 60. The fastener 140 may include a first fastener 141 and a second fastener 142.

The first fastener 141 may be a coupling structure formed on the holder 110, and the second fastener 142 may be a coupling structure formed on the housing 60. The first fastener 141 and the second fastener 142 may be coupled to each other using the respective coupling structures thereof to couple the holder 110 and the housing 60. The coupling may be via, without limitation, a concave-convex engagement.

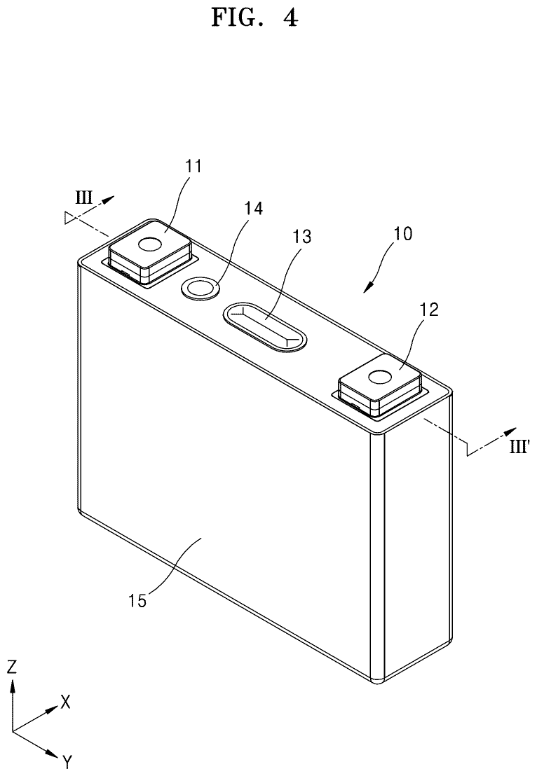

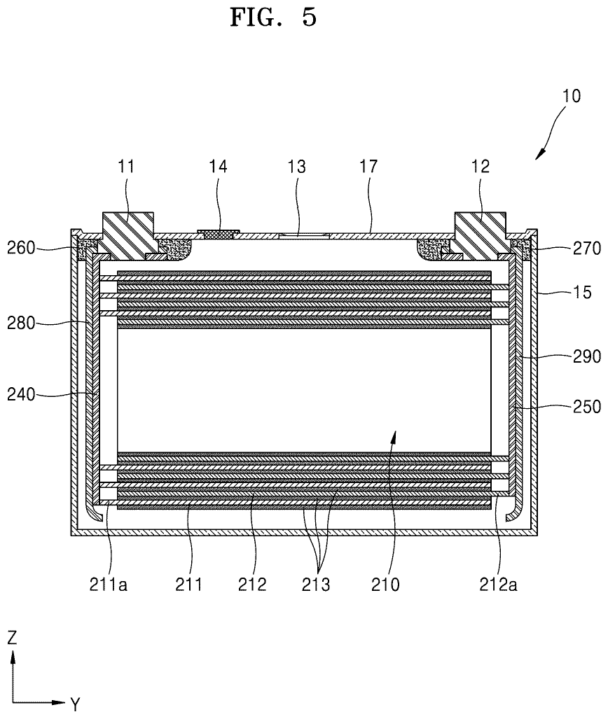

FIG. 4 is a perspective view of a battery cell of the battery module shown in FIG. 1 according to one or more embodiments of the disclosure, and FIG. 5 is a cross-sectional view of the III-III′ cross-section shown in FIG. 4 according to one or more embodiments of the disclosure.

Referring to FIG. 4 to FIG. 5, the battery cell 10 according to one embodiment may include at least one electrode assembly 210 and a case 15 in which the electrode assembly 210 is housed The electrode assembly 210 may be formed by winding a positive electrode 211, a negative electrode 212, and a separator 213, which is an insulator provided between the positive electrode 211 and the negative electrode 212.

The battery cell 10 according to one embodiment is described as a lithium-ion battery cell having a prismatic shape by way of example. However, the disclosure is not limited thereto, and the disclosure may be applied to various types of battery cells, such as lithium polymer battery cells or cylindrical battery cells.

Each of the positive electrode 211 and the negative electrode 212 may include a coated portion, which is a region where a collector formed of a thin metal foil is coated with an active material, and an uncoated portion 211a or 212a which is a region not coated with the active material.

The positive electrode 211 and the negative electrode 212 are wound after the separator 213, the insulator, is provided between the positive electrode 211 and the negative electrode 212. However, the disclosure is not limited thereto, and the above-described electrode assembly 210 may also have a structure in which the positive electrode formed of a plurality of sheets and the negative electrode formed of a plurality of sheets are alternately stacked on the opposite sides of the separator 213.

The case 15 may form the overall contour of the battery cell 10, and may be formed of a conductive metal such as aluminum, an aluminum alloy, or nickel-plated steel. In some embodiments, the case 15 may provide a space in which the electrode assembly 210 is accommodated.

The battery cell 10 may include a cap plate 17 covering an opening in the case 15, and the case 15 and the cap plate 17 may be formed of a conductive material. In this case, the first terminal 11 and the second terminal 12 electrically connected to the positive electrode 211 or the negative electrode 212 may be disposed or arranged to protrude outward through the cap plate 17.

In some embodiments, the outer circumferential surfaces of the upper posts of the first terminal 11 and the second terminal 12 protruding outward from the cap plate 17 may be threaded, and may be fixed to the cap plate 17 with nuts.

However, the disclosure is not limited thereto, and each of the first terminal 11 and the second terminal 12 may have a rivet structure to be riveted to the cap plate 17 or may be welded to the cap plate 17.

In some embodiments, the cap plate 17 may be implemented as a thin plate to be coupled to the opening in the case 15, may be provided with an electrolyte inlet 14 in which a sealing stopper may be disposed or arranged, and may be provided with a vent 13 having a notch.

The first terminal 11 and the second terminal 12 may be electrically connected to collectors including first and second collectors 240 and 250 (hereinafter, also referred to as positive and negative electrode collectors) welded to the positive electrode uncoated portion 211a or the negative electrode uncoated portion 212a.

For example, the first terminal 11 and the second terminal 12 may be welded to the positive electrode collector 240 and the negative electrode collector 250. However, the disclosure is not limited thereto, and the first and second terminals 11 and 12 and the positive and negative electrode collectors 240 and 250 may be formed as an integrated structure.

In some embodiments, insulating members may be disposed between the electrode assembly 210 and the cap plate 17. In this case, the insulating members may include first and second lower insulating members 260 and 270, each of which may be disposed between the electrode assembly 210 and the cap plate 17.

In some embodiments, according to the present embodiment, separating members may be disposed to face respective sides of the electrode assembly 210, and one ends of the separating members may be disposed between the insulating members and the first and second terminals 11 and 12.

In this case, the separating members may include first and second separating members 280 and 290.

In some embodiments, the one ends of the first and second separating members 280 and 290, which may be disposed to face the respective sides of the electrode assembly 210, may be disposed between the first and second lower insulating members 260 and 270 and the first and second terminals 11 and 12.

As a result, the first and second terminals 11 and 12 welded to the positive and negative electrode collectors 240 and 250 may be coupled to the first and second lower insulating members 260 and 270 and the one ends of the first and second separating members 280 and 290.

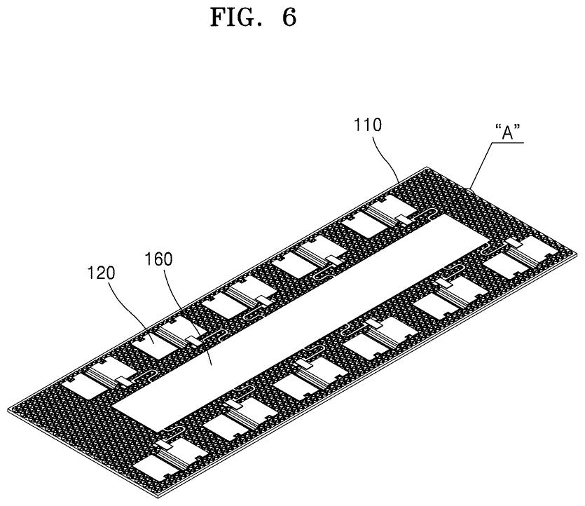

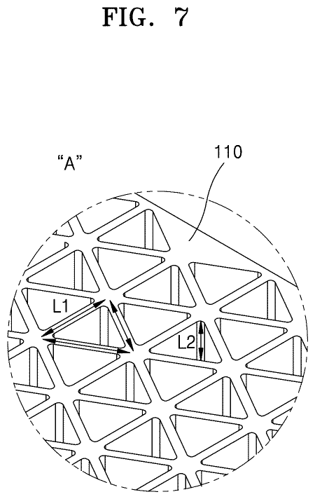

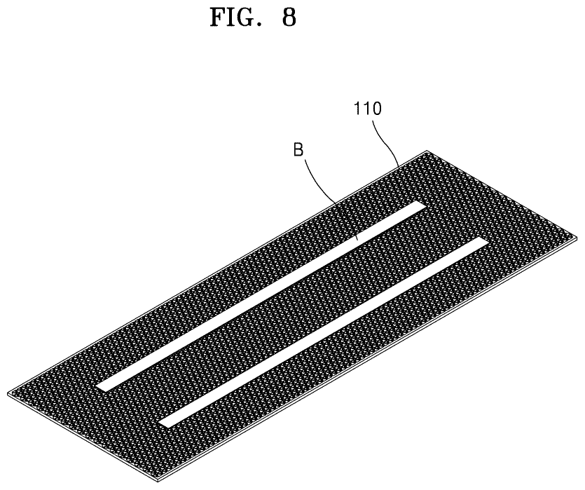

FIG. 6 is a perspective view of a holder including busbars in the battery module shown in FIG. 1 according to one or more embodiments of the disclosure. FIG. 7 is an enlarged view of the holder shown in FIG. 6 according to one or more embodiments of the disclosure. FIG. 8 is a perspective view of a rear side of the holder shown in FIG. 6 according to one or more embodiments of the disclosure.

Referring to FIGS. 6 to 8, the holder 110 included in the battery module 100 may include a honeycomb structure, and the busbars 120 may be positioned on the honeycomb structure.

In some embodiments, the honeycomb structure included in the holder 110 may refer to a structure in which polygonal structures are connected to adjacent structures, and desirably may refer to a structure in which hexagonal structures are connected to adjacent structures.

In an embodiment in which the battery cells 10 are electrically connected to each other by the busbars 120, it may be desirable to reduce or prevent short-circuiting between the battery cells 10. In some embodiments in which the holder 110, which includes the busbars 120 electrically connecting the battery cells 10, has a honeycomb structure, the clearance distance and/or creepage distance between adjacent busbars 120 increases.

In some embodiments, the clearance distance refers to the shortest distance between two conductors in the air, and specifically, refers to the shortest distance between two busbars 120 in the air. The clearance distance may also be referred to as an air gap.

In some embodiments, the creepage distance refers to the shortest distance along the surface of the insulating material between two conductors, and specifically, refers to the shortest distance along the surface of the holder 110 between two busbars 120. The creepage distance may also be referred to as a surface separation distance.

In some embodiments, the honeycomb structure may be formed as a triangular lattice structure, and desirably, have a hexagonal structure including six triangular structures, wherein the six triangular structures may share the center of a virtual circle of the honeycomb structure as one vertex, and accordingly, may be expressed as three pairs symmetrical to the center of the virtual circle. In this regard, the honeycomb structure may be a grid formed by repeating equilateral triangles.

In some embodiments, the length L1 of one side of the honeycomb structure may be in a range from approximately 1.0 mm to approximately 10 mm, greater than approximately 1.5 mm and equal to or less than approximately 10 mm, and about 2 mm.

In an embodiment in which the length of one side of the honeycomb structure is within the above-described numerical range, the creepage distance between adjacent busbars 120 may increase, helping improve the insulation performance of the holder 110 including the honeycomb structure.

In a case in which the length of one side of the honeycomb structure is less than the lower limit of the above-described numerical range, the creepage distance between adjacent busbars 120 may decrease, which may lead to poor insulation performance of the holder 110 including the honeycomb structure. In a case in which the length is greater than the upper limit of the above-described numerical range, the rigidity of the holder may decrease and the space utilization of the holder 110 in the battery module 100 may decrease.

In some embodiments, in an embodiment in which the holder 110 includes a honeycomb structure, the volume change caused by battery charging and discharging may be stably managed.

The volume of the battery cell 10 may repeatedly expand and contract in response to charging and discharging of the battery cell 10. Despite the volume change of the battery cell 10, however, the overall volume of the battery module 100 should be maintained unchanged. In this case, the holder 110 is in contact with the battery cell 10 on one side, and in an embodiment in which the holder 110 includes a honeycomb structure, the volume change of the battery module 100 may be managed even when the volume of the battery cell 10 changes due to charging and discharging of the battery cell 10.

In some embodiments, the thickness L2 of the holder 110 may be in range from approximately 1.0 mm to approximately 10 mm, greater than approximately 1.5 mm and equal to or less than approximately 10 mm, and about 2 mm (see FIG. 7).

In an embodiment in which the thickness of holder 110 is within the above-described numerical range, the creepage distance between the busbar 120 and the battery cell 10 may increase, helping improve the insulation performance of the holder 110 including the honeycomb structure.

In a case in which the thickness of the holder 110 is less than the lower limit of the above-described numerical range, the creepage distance between the battery cell 10 and the busbar 120 may decrease, which may lead to poor insulation performance of the holder 110 including the honeycomb structure. In a case in which the thickness is greater than the upper limit of the above-described numerical range, tthe rigidity of the holder may decrease and the space utilization of the holder 110 in the battery module 100 may decrease.

In some embodiments, the battery module 100 may include adhesive portions B for bonding the plurality of battery cells 10 and the holder 110.

In one embodiment of the battery module 100, the holder 110 is formed on the plurality of battery cells 10, and the plurality of battery cells 10 are in contact with the holder 110 on one side. In this case, the adhesive portions B may be included on the one side of the holder 110 with which the plurality of battery cells 10 are in contact.

In some embodiments, the adhesive portions B may include an adhesive material, all or part of which is impregnated or injected into the honeycomb structure.

Because the holder 110 includes a honeycomb structure, into which all or part of the adhesive material is injected, the adhesive portions B of the holder 110 may be bonded to the plurality of battery cells 10.

In some embodiments, because the holder 110 forms a honeycomb structure to form a wide area into which the adhesive material may be injected, the bond between the plurality of battery cells 10 and the holder 110 may be strengthened.

In some embodiments, the battery module 100 may include a printed circuit board 160 which is positioned on the holder 110 and is electrically connected to the busbars 120.

The printed circuit board 160 is used for mounting and electrically connecting parts of an electronic device, and the printed circuit board 160 having one or more parts mounted thereon may be included in the battery module 100.

In some embodiments, the battery module 100 including the printed circuit board 160 on which the plurality of parts are mounted may be implemented as a battery management system (BMS).

According to embodiments of the disclosure, a battery module which reduces or prevents short-circuiting between battery cells is provided.

A battery module able to manage (e.g., stably manage) a volume change caused by charging and discharging of a battery is also provided.

In some embodiments, a battery module which includes a plurality of battery cells and a holder having improved adhesive performance is also provided.

However, the effects of the disclosure are not limited to those described above, and other technical effects not mentioned will be apparent to a person of ordinary knowledge in the art from the following description of the disclosure.

Although the disclosure has been described hereinabove with reference to the specific embodiments and the drawings, the disclosure is not limited thereby, and various modifications and changes are possible by a person of ordinary knowledge in the art to which the disclosure pertains, within the spirit of the disclosure and the equivalents of the following claims.

What is claimed is:

1. A battery module comprising:
a plurality of battery cells;
one or more busbars configured to electrically connect the plurality of battery cells; and
a holder on the plurality of battery cells and configured to accommodate the busbars,
wherein the holder comprises a honeycomb structure, and
the one or more busbars are on the honeycomb structure.

2. The battery module of claim 1, further comprising a housing configured to house the plurality of battery cells.

3. The battery module of claim 2, further comprising a fastener configured to fasten the holder and the housing.

4. The battery module of claim 1, further comprising an adhesive portion configured to bond the plurality of battery cells and the holder.

5. The battery module of claim 4, wherein the adhesive portion comprises an adhesive material, all or part of which is injected into the honeycomb structure.

6. The battery module of claim 1, further comprising a cover on the holder and configured to cover the busbars.

7. The battery module of claim 6, further comprising an upper cover configured to cover the cover,
wherein the cover is coupled to the upper cover.

8. The battery module of claim 1, wherein the holder has a thickness in a range from approximately 1.0 mm to approximately 10 mm.

9. The battery module of claim 1, wherein the honeycomb structure has a triangular lattice structure.

10. The battery module of claim 1,
wherein one side of the honeycomb structure has a length in a range from approximately 1.0 mm to approximately 10 mm.

11. A battery module comprising:
a plurality of battery cells;
one or more busbars configured to electrically connect the plurality of battery cells;
a holder on the plurality of battery cells and configured to accommodate the busbars; and
a printed circuit board on the holder and electrically connected to the busbars,
wherein the holder comprises a honeycomb structure, and
the printed circuit board and the busbars are on the honeycomb structure.

12. The battery module of claim 11, further comprising a housing configured to house the plurality of battery cells.

13. The battery module of claim 12, further comprising a fastener configured to fasten the holder and the housing.

14. The battery module of claim 11, further comprising an adhesive portion configured to bond the plurality of battery cells and the holder.

15. The battery module of claim 14, wherein the adhesive portion comprises an adhesive material, all or part of which is injected into the honeycomb structure.

16. The battery module of claim 11, further comprising a cover on the holder and configured to cover the busbars.

17. The battery module of claim 16, further comprising an upper cover configured to cover the cover,
wherein the cover is coupled to the upper cover.

18. The battery module of claim 11, wherein the holder has a thickness in a range from approximately 1.0 mm to approximately 10 mm.

19. The battery module of claim 11, wherein the honeycomb structure has a triangular lattice structure.

20. The battery module of claim 11, wherein one side of the honeycomb structure has a length in a range from approximately 1.0 mm to approximately 10 mm.
